(19) United States
(12) Patent Application Publication
(10) Pub. No.: US 2014/0270393 A1
(43) Pub. Date: Sep. 18, 2014

(54) SYSTEMS AND METHODS FOR IMPROVING DIRECT NUMERICAL SIMULATION OF MATERIAL PROPERTIES FROM ROCK SAMPLES AND DETERMINING UNCERTAINTY IN THE MATERIAL PROPERTIES

(71) Applicants: Laurent Louis, Katy, TX (US); Joanne Fredrich, Houston, TX (US); Elizabeth Liu, Houston, TX (US); Dianne Ni, Katy, TX (US)

(72) Inventors: Laurent Louis, Katy, TX (US); Joanne Fredrich, Houston, TX (US); Elizabeth Liu, Houston, TX (US); Dianne Ni, Katy, TX (US)

(73) Assignee: BP Corporation North America Inc., Houston, TX (US)

(21) Appl. No.: 13/836,483

(22) Filed: Mar. 15, 2013

(51) Int. Cl. G06K 9/00

(52) U.S. Cl. CPC G06K 9/00577
USPC 382/109

(57) ABSTRACT

A testing system can analyze a 3D digital volume of a material sample. The testing system can define several test volumes with each test volume including a different numbers of voxels. The test volumes can define the size of portions of the 3D digital volume to analyze. For each test volume, the testing system can acquire two adjacent portions of 3D digital volume that are the size of the test volume currently being analyzed. The testing system can calculate a petrophysical property value for the two adjacent portions of the 3D digital volume and can calculate the difference value between the two adjacent portions of the 3D digital volume. The testing system can repeat the process for the different test volumes. The testing system can plot the mean difference values for the different test volumes. The testing system can analyze the plot to determine a representative elementary volume that meets a predefined difference value.

### CROSS-REFERENCE TO RELATED APPLICATIONS

None.

### TECHNICAL FIELD

This disclosure relates generally to methods and systems for analyzing three dimensional digital volumes of material samples to determine petrophysical properties.

### BACKGROUND

Obtaining petrophysical properties of subsurface rock is important for assessing volumes in place and for formulating a development strategy. Traditionally, samples of the rock formation can be subjected to physical laboratory tests to determine the petrophysical properties. These tests, however, are typically time consuming and expensive. Hence, there is a desire to develop technologies that can assist with obtaining reliable estimates of petrophysical properties at a fraction of the time and cost of traditional laboratory based approaches.

Direct numerical simulation of petrophysical properties from digital images of rock is one promising technology aimed at achieving these objectives. To determine the petrophysical properties utilizing this approach, often an x-ray tomographic image is taken of a rock sample and a computational experiment is applied on the digital rock volume which simulates a specific physical experiment. Usually, physical properties, such as porosity, absolute permeability, relative permeability, formation factor, elastic moduli can be determined using this approach.

Relative to experimentally derived petrophysical properties, direct numerical simulation has the potential to provide petrophysical properties of difficult rock types, such as tight gas sands or carbonates within a timeframe that is substantially shorter. The reason is that achieving the physical conditions necessary for a specific experiment to proceed such as full water saturation can be a slow physical process. However, usually the analogous numerical conditions necessary to replicate the physical experiment can be easily achieved.

For most rock types it is necessary to acquire high resolution images of the rock, so that the pore space can be resolved. This usually means that images are taken on a smaller rock sample. The smaller rock sample can be extracted from a larger rock sample such as a plug, rotary core or whole core. The implications are that pore system heterogeneity may not always be represented well within the imaged portion of the rock. In some cases, the computational domain is too small for the pore system and the computed petrophysical properties fluctuate significantly about the true value for the rock.

Often practitioners conducting direct numerical simulation of petrophysical properties from experimentally acquired images ignore this issue. That is, computations are performed on the largest possible volume extracted from the image, without conducting further analysis to assess whether the computational domain is appropriate for the pore system. Thus, the computed petrophysical properties may be in error due to lack of pore system representativeness.

To establish whether computed petrophysical properties are impacted by a lack of pore system representativeness, Representative Elementary Volume (REV) analysis is sometimes performed. This approach is quantitative, in that if a representative elementary volume is shown to exist, its size is also determined. By conducting this analysis, the effect of pore scale variability and scale dependence on petrophysical properties can be directly assessed.

Traditionally, the REV has been defined as the volumetric extent of a rock from which computational measurements/or experiments made result in values which are representative of the larger, or macroscopic, rock mass. That is, the REV is defined as the volume at which the physical parameter, which is computed/measured, is dependent on the content of the volume only, as opposed to also being dependent on the size of the volume. When computational measurements or experiments are made on volumes of rock smaller than the REV, the computational/experimental data oscillate. As the size of the volume approaches that of the REV, there is a damping of the oscillations towards the representative value. Computations/experiments performed on volume sizes greater than the representative volume result in values equivalent to those obtained on the volume defined as the REV (i.e., the representative value), providing no macroscale heterogeneities are present.

FIG. 1 illustrates the traditional definition of the REV for porosity for a porous medium. In FIG. 1, the sampling volume is denoted by ΔVᵢ, the REV volume is denoted by ΔV₀ and nᵢ is the void space volume divided by the sampling volume. For sampling volumes ΔVᵢ<ΔV₀, there are only a small number of pores and grains present (FIG. 2, left pane: sampling volume ΔVᵢ smaller than REV ΔV₀ volume, porosity calculation for volume reflects local pore scale variability and not the porosity of the porous medium.) This means that porosity of the volume is not strictly defined as there isn't a sufficient number of pores and grains to permit a physically meaningful statistical average to be determined. As volume sizes continue to decrease, the calculated ratio of void space to total volume will approach one or zero depending on whether the centroid P of the sampling volume is situated within a pore or grain. Here nᵢ is dominated by local micro scale variability of the pore space.

For sampling volumes ΔVᵢ→ΔV₀, there are a sufficient number of pores and grains to permit a physically meaningful statistical average to be determined (FIG. 2 right pane: sampling volume ΔVᵢ greater than REV ΔV₀, porosity calculation over volume reflects porosity value of porous medium.) Here, the porosity of the porous medium is first defined (i.e. nᵢ=φ). Whereas for sampling volumes ΔV>>ᵢΔV₀, the porosity of a homogenous porous medium is constant and equivalent to the porosity at REV volume size. However, for an inhomogeneous porous medium, fluctuations in the porosity will occur when the volume size is impacted by macroscale inhomogeneities.

The classical definition of the REV underpins the continuum framework for definition of petrophysical properties of porous materials. That is, porosity, permeability, formation factor, etc. are all defined as volumetric averages of microscopic properties over the REV volume. Moreover, an REV volume for one petrophysical property, such as porosity may not necessarily form an REV volume for another petrophysical property, such as permeability.

When utilizing direct numerical simulation or calculation of petrophysical properties from x-ray tomographic images or other experimentally acquired images, both the presence and size of the classical REV can be quantified for a specific pore system. The REV can be quantified for porosity, permeability and specific surface area for x-ray tomographic images of sandstone. REV can be determined by two different approaches. The first approach consists of selecting a fixed location within the digital volume. Around that location point, an averaging volume is specified of certain scale. Over the averaging volume the porosity, permeability and specific surface is calculated. The size of the averaging volume is then incrementally increased and the properties recalculated. The second approach relates to determining a statistical representative elementary volume, for this case the average statistical properties of the quantity of interest are considered. That is, the SREV is defined as the volume size below which the average of the property begins to fluctuate. The statistical average is determined by choosing volumes of the specified size at a number of different locations throughout the volume and computing the petrophysical property at that point.

### SUMMARY

Implementations of the present teachings relate to a method for analyzing material samples to determine physical properties. The method can include receiving a three-dimensional (3D) digital volume of a material sample. Further, the method can include defining a plurality of test volumes, wherein each of the plurality of test volumes comprises a number of voxels, and wherein the number of voxels for each of the plurality of test volumes is different. Additionally, the method can include determining, for each of the plurality of test volumes, a difference value between a petrophysical property for two adjacent test volumes from the 3D digital volume, each adjacent test volume comprising the number of voxels associated with the test volume. The method can also include plotting the difference value for each of the plurality of test volumes and determining, from the plot of the difference values, a representative elementary volume for testing the material sample.

According to implementations, determining the difference value for each of the plurality of test volumes can include selecting a first portion of the 3D digital volume containing the number of voxels and selecting a second portion of the 3D digital volume that is adjacent to the first portion and contains the number of voxels. Then, the method can include calculating a first petrophysical property value for the first portion and calculating a second petrophysical property value for the second portion. Further, the method can include calculating a difference value based on the first petrophysical property value and the second petrophysical property value.

### BRIEF DESCRIPTION OF THE DRAWINGS

Various features of the implementations can be more fully appreciated, as the same become better understood with reference to the following detailed description of the implementations when considered in connection with the accompanying figures, in which:

FIG. 1 is a diagram that illustrates a traditional definition of the REV for porosity for a porous medium.

FIG. 2 is a diagram that illustrates examples of sampling volumes.

FIG. 3 is a diagram that illustrates an example of an x-ray tomographic image acquired from a sandstone rock sample under ambient pressure and dry fluid saturation, according to various implementations.

FIG. 4 is a diagram that illustrates an example of an application of a simple segmentation algorithm to the x-ray tomographic image of FIG. 3, according to various implementations.

FIG. 5 is a diagram that illustrates an example of a constructed volume generated by a cubic packing of spheres, according to various implementations.

FIG. 6 is flow diagram that illustrates an example of a process utilized to analyze 3D digital volumes, according to various implementations.

FIG. 7 is a diagram that illustrates an example of sampling strategy, according to various implementations.

FIG. 8 is a diagram that illustrates one example in which the test volume sizes can be chosen to sample a 3D digital volume, according to various implementations.

FIG. 9 is a diagram that illustrates an example of a rock sample and an example of a plot of the difference values, according to various implementations.

FIG. 10 is a diagram that illustrates an example of a study of REV % for porosity uncertainty for four different digital volumes, according to various implementations.

FIG. 11 is a diagram that illustrates an example of an x-ray tomographic image and an example of a plot to assess anisotropy, according to various implementations.

FIG. 12 is a generic block diagram that illustrates components of a computing device, according to various implementations.

### DETAILED DESCRIPTION

For simplicity and illustrative purposes, the principles of the present teachings are described by referring mainly to examples of various implementations thereof. However, one of ordinary skill in the art would readily recognize that the same principles are equally applicable to, and can be implemented in, all types of information and systems, and that any such variations do not depart from the true spirit and scope of the present teachings. Moreover, in the following detailed description, references are made to the accompanying figures, which illustrate specific examples of various implementations. Electrical, mechanical, logical and structural changes can be made to the examples of the various implementations without departing from the spirit and scope of the present teachings. The following detailed description is, therefore, not to be taken in a limiting sense and the scope of the present teachings is defined by the appended claims and their equivalents.

Implementations of the present teachings relate to systems and methods for (1) enhancing the direct numerical simulation of physical properties and (2) determining the uncertainty in the simulated physical properties, whereby direct numerical simulation or calculation can be performed upon various digital volumes including, but not limited to, experimentally acquired image volumes of porous material, derivative volumes attained from image volumes and constructed volumes generated using numerical processes. In implementations, a three dimensional (3D) image volume, can include image volumes acquired utilizing experimental techniques like, x-ray tomography, Focused Ion Beam Scanning Electron Microscopy, Nuclear Magnetic Resonance and Neutron tomography. Derivative volumes can include digital volumes attained by applying segmentation processes or other image processing methods on image volumes. Constructed volumes refer to data volumes generated using numerical processes, they may be statistically driven, geologically modeled or a result of data mining or machine learning.

Each digital volume can be partitioned into 3D regular elements called voxels. Generally, each voxel is cubic in dimension having a side length equal in x, y, and z directions. The digital volume can contain a different number of voxels in x, y and z directions. Each voxel within a digital volume has an assigned numeric value also known as amplitude. The nature of the numeric value depends on the type of digital volume. That is, image volumes often have a range of numeric values from a lower limit to an upper limit, these limits depend on the acquisition system, in particular whether the data is stored as 8 bit or 16 bit, etc. This range is commonly known as the grayscale range of an image. For example, a typical x-ray tomographic image volume acquired utilizing 16 bit data can have voxels with amplitudes ranging from 0 to 63535. The amplitude of a particular voxel depends on the relative material properties of the imaged sample at that location.

As described herein, relative material properties mean the material properties of the sample at a specific location relative to the material properties of the sample at another location. For acquisition systems utilizing x-rays, the relative material properties can be a measure of the relative density at a specific location. FIG. 3 illustrates one example of an input type for the process described below, according to various implementations. In particular, FIG. 3 illustrates an x-ray tomographic image acquired from a sandstone rock sample under ambient pressure and dry fluid saturation. The image volume shows a range of grayscale values, which represent the intensity of the x-ray absorption within the sample. Variation in grayscale data resulting from different amounts of x-ray absorption can be correlated to changes in material density throughout the rock sample.

Derivative volumes can contain voxels which have their original amplitude value modified. In some situations, the modification can be a result of image processing routines, such as artifact reduction or noise filtering, which seek to minimize artifacts/noise generated during acquisition. Usually, this form of image enhancement is applied during the image acquisition stage, but it may also be applied subsequently to improve the quality of the image data. In other circumstances, segmentation can be performed. In segmentation, voxels are assigned a restricted set of numeric values generally for feature identification. The assignment of voxel values can be a result of an automated numerical process or hand-picked process. Both approaches can assess characteristics of an image, derivative, or constructed volume. These characteristics can include voxel amplitude, voxel amplitude connectivity or disconnectedness, or shape of connected/disconnected amplitude bodies.

For example, one type of segmentation process is called Thresholding. Thresholding can commonly be utilized to separate pore space from grain space within an image volume. A threshold value is chosen within the voxel amplitude range. Voxels having amplitudes below the threshold value are assigned a specific numeric value to denote pore space, while voxels having values above the threshold are assigned another numeric value to denote grain space. In this instance, the Thresholding process converts a grayscale image volume to a derivative volume consisting of two numeric values, commonly 0 and 1. Thresholding can be applied any number of times to denote various features within a grayscale image.

Another example of a segmentation process is called Otsu's method. The Otsu's method includes a histogram-based thresholding technique, where the threshold is chosen so that the variance between a bimodal distribution of grayscale values is minimized. This method can be automated and can also be extended for thresholding a number of times. There are also other examples of automated segmentation algorithms of varying complexity which can be utilized to distinguish different features of an image volume, such as Indicator Kriging, Converging Active Contours, Watersheding, etc.

FIG. 4 illustrates an example of an application of a simple segmentation algorithm to the x-ray tomographic image of FIG. 3, according to various implementations. As illustrated in FIG. 4, the segmentation algorithm has been utilized to convert a grayscale micro-tomographic image into a derivative volume. The black colored portions of the volume are labeled as pore space. The gray portions of the volume are labeled as grain space.

Constructed volumes refer to digital volumes which are usually algorithmically generated. The numerical algorithms can vary in complexity, from replicating granular and porous material by producing cubic packing of spheres, randomly inserting spheres into a cubic volume, or mimicking depositional and compaction processes. Sometimes geostatistical routines can be utilized to generate random binary media, based on correlation functions and the like. Generally, the constructed volumes do not require subsequent segmentation to identify different features of the digital volume, as usually there is sufficient algorithmic labeling. However, in some circumstances it may be necessary to perform subsequent segmentation to identify additional features within the constructed digital volume. FIG. 5 illustrates an example of a constructed volume generated by a cubic packing of spheres, according to various implementations. As illustrated in FIG. 5, the cubic packing of spheres has been generated numerically by inserting spheres of uniform radius into a three dimensional cubic lattice.

According to implementation of the present disclosure, a testing tool can be utilized to analyze 3D digital volumes including 3D digital image volumes, derivative volumes, and constructed volumes. The 3D digital volumes can be based on 3D digital image volumes of rock samples. The rock samples can be obtained from whole core, side wall cores, outcrops, drill cuttings and laboratory generated synthetic rock samples, such as sand packs and cemented packs. The 3D image volumes of rock samples can be acquired under ambient pressure conditions, under confining stress, having fluid saturation and under an assortment of other experimental conditions. Additionally, the testing tool can be utilized to perform the processes described herein on 3D digital volumes of other porous materials, such as paper, bone, etc.

The testing tool can be implemented as software, hardware, or a combination of both software and hardware. As such, the testing tool can include the necessary logic, instructions, routines, and algorithms to perform the functionality and processes described herein. For example, the testing tool can be a standalone application program or can be a program module that is part of another application or program.

FIG. 6 illustrates an example of a process 600 for analyzing a 3D digital volume, according to various implementations. In the process 600, the illustrated stages are examples and any of the illustrated stages can be removed, additional stages can be added, and the order of the illustrated stages can be changed.

In 602, the process can begin. In 604, the testing tool can define one or more test volumes containing a different number of voxels. For each test volume, the testing tool can acquire two adjacent portions of 3D digital volume that are the size of the test volume currently being analyzed. In particular, in 606, the testing tool can acquire first volume of the 3D digital volume that is equal to a test volume. In 608, the testing tool can acquire a second volume of the 3D digital volume that is adjacent to the first volume and equal to the test volume.

In 610, the testing tool can calculate the petrophysical properties for each of the acquired volumes. The testing tool can calculate, using direct numerical simulation or other methods, material properties. The petrophysical properties can include physical properties, such as porosity, absolute permeability, relative permeability, electrical properties, elastic properties, NMR, etc. The material properties can also include geometrical properties, such as correlation lengths, surface to volume ratio, chord lengths, pore throat radii, grain size and grain shape, etc. for the two adjacent portions of the 3D volume. That is, for a segmented derivative volume, porosity can be obtained by dividing the total number of pore space voxels by the total number of voxels contained within the test volume. On the other hand, absolute permeability can be computed by using a variety of numerical methods such as finite element, finite difference or lattice Boltzmann (LB) methods. These numerical approaches can simulate the physics of single phase fluid flow to compute permeability by either directly solving/approximating the Navier-Stokes equations or recovering the Navier-Stokes equation from a discretization of the Boltzmann equation. Geometrical properties, such as correlation lengths, chord lengths, etc. can be obtained using Monte Carlo-like methods, where certain characteristics are randomly sampled throughout each adjacent test volume. For instance, the correlation length can be estimated by randomly sampling two points displaced at a given distance.

In 612, the testing tool can then calculate the difference value between the two petrophysical properties extracted from adjacent test volumes of the 3D volume. The difference value can represent the percentage difference in the physical or geometrical property values between the two adjacent portions. The testing tool can calculate either the mean of the difference value for the set of adjacent test volumes or can calculate the cumulative mean of the difference values of all previously selected adjacent test volumes and use convergence of the cumulative mean to a value as stopping criterion for selection of further adjacent test volumes. The mean of the difference value for the set of adjacent test volumes or the cumulative mean can be used to determine a difference value that is representative of the specific test volume size. As described herein, the mean of the difference value can also be understood as including the cumulative mean of the difference value.

In 614, the testing tool can repeat for additional sample of the first volumes and second volumes of the 3D digital volume. The testing tool can use a sampling strategy to select a number of adjacent test volumes. The total number of adjacent test volumes selected can be fixed to a certain number or can vary according to a convergence criterion. The location of the two adjacent test volumes can be selected randomly, systematically, or according to a stratified strategy providing both adjacent test volumes lie within the entire 3D digital volume. The choice of sampling strategy depends on the heterogeneity or homogeneity of the pore structure. For instance, if the pore structure appears homogeneous on a scale much less than the initial test volume size, then a systematic sampling strategy can provide a more efficient method to sample the 3D digital volume than straight random sampling. That is, two adjacent test volumes are selected at a sampling interval specified by a fixed number of voxels from the previous two adjacent test volumes, where the first two adjacent test volumes of the series are chosen at a random location within the 3D volume. FIG. 7 illustrates an example of sampling strategy, according to various implementations. As illustrated in FIG. 7, the testing tool can utilize random sampling. In this example, three different adjacent test volumes have been selected to sample the 3D volume. The squares can represent a cubic volume, which samples the porous medium at random spatial locations given by (xᵢ, yᵢ, zᵢ) where i=1:n.

In 616, the testing tool can calculate and plot mean difference values for test volume data and analyze the plot of the mean difference value. The testing tool can analyze the plot to determine a representative elementary volume (REV) that meets a predefined difference value. Likewise, the plot of the mean difference values can be utilized to determine the uncertainty in petrophysical properties that are calculated or numerically simulated using portions of the 3D volume having different sizes.

In 618, the testing tool can repeat the process for additional sample volumes. The additional sample volumes can include the same test volume size. Likewise, the additional sample volumes can include different test volume sizes in order to determine the mean difference value for different sized portions of the 3D digital volume. The different test volume sizes can be selected incrementally to include greater voxels or fewer voxels. FIG. 8 illustrates one example in which the test volume sizes can be chosen to sample a 3D digital volume, according to various implementations. As illustrated in FIG. 8, the test volume size changes using increments of 25 voxels. That is, the first test volume size is 25 voxels, the second test volume size is 50 voxels, the third test volume size is 75 voxels, and so on. In FIG. 8, size refers to the length in voxels of one side of the cubic volume.

In 620, the process can end, return to any point, or repeat.

By calculating the difference values and the representative elementary volume, the testing system can improve the efficiency by determining an ideal size of a digital volume to analyze that minimizes the uncertainty in the physical properties simulated due to heterogeneity within the input volume. As such, the testing system can determine a testing size that minimizes the uncertainty in the physical property values without unduly increasing the size of a portion of the digital volume to analyze. Accordingly, the testing tool and system can improve both computational accuracy and computational efficiency.

In implementations, the testing tool can utilize the process described above to determine the representative elementary volume (REV) for a rock sample. As described herein, REV is defined as being a volume size for which a mean difference value [symbol] p [symbol] or [symbol] p % [symbol] of calculated petrophysical property values between two adjacent portions of a digital volume of that size differ by predetermined percentage difference value REV %. FIG. 9 illustrates an example of a rock sample and an example of a plot of the difference values, according to various implementations. FIG. 9 (right pane) shows the plot of the mean difference values for porosity, here labeled as REV % volumes. The plot shows the porosity uncertainty curve by a power law fit and REV % volumes. The arrows point to REV 10% volume and REV 5% volume sizes. Thus, the smaller the REV % for a given test volume size, the closer the physical or geometrical property values are between the two adjacent portions of the 3D digital volume. FIG. 9 (left pane) illustrates an x-ray tomographic image of rock having domain size of approximately 5000 microns. REV volumes for 5% (˜1200 microns) and 10% (˜800 microns) porosity uncertainty are shown. This illustrates the REV volume sizes for both 5% and 10% porosity uncertainty.

The testing tool can define the pre-determined percentage as any percentage difference value REV % that provides a desired percentage difference value between two adjacent test volumes while reducing the size of the test volume. As such, the testing tool can determine a REV that balances the REV % with the size of the test volume. FIG. 10 illustrates one study of REV % for porosity uncertainty for four different digital volumes, according to various implementations. The image domain size is given by the black bar, the mid gray bar shows the 5% uncertainty in porosity domain size, and the light gray bar shows the 10% porosity uncertainty domain size. The greater the difference in domain sizes between the digital volume and the specified REV % domain size the greater the computational savings by using the REV volume. Alternatively, if the computation proceeds on the full domain, there is more certainty that the computation of the petrophysical property is not affected by local heterogeneity within the digital volume.

The testing tool can calculate the difference value p and difference value percentage p % using

p=2×abs(V_{A}−V_{B})/(V_{A}+V_{B}), and p%=100*p;

where V_{A}, V_{B} are either physical or geometrical property values calculated or simulated for the adjacent volumes. The testing tool computes the difference value p a number of times for each test volume size. From the set of difference values for each test volume size, the mean difference value or mean difference value as a percentage [symbol] p % [symbol] may be calculated using

$$〈 p 〉 = \frac{1}{n} {\sum }_{i = 1}^{n} {p}_{i}$$

$$or$$

$$〈 p \% 〉 = \frac{1}{n} {\sum }_{i = 1}^{n} p {\%}_{i}$$

where n is the total number of times the difference value p (or percentage p %) has been computed for each test volume size and i refers to the difference value p (or percentage difference value p %) for a specific instance of two adjacent volumes. When the testing tool utilizes a cumulative mean difference value p or percentage p %, after the difference value p (or difference value percentage p %) is computed for two adjacent volumes, the mean difference value p (or mean difference value percentage p %) is calculated using that value and any previous values calculated for that test volume size.

The testing tool can be configured to analyze anisotropy within the digital volume by conducting the REV analysis in orthogonal directions. For example, the testing tool can be configured to conduct REV analysis by selecting adjacent test volumes, so as that they are aligned in the x-direction. The testing tool can then be configured to conduct REV analysis by selecting adjacent test volumes, so as that they are aligned in the z-direction. The testing tool can then compare the plots of the mean difference value percentage or the cumulative mean difference value percentage for each direction. If anisotropy is present within the volume, there is a difference in the shape of the mean (or cumulative mean) difference curves for each direction. FIG. 11 illustrates an example of an x-ray tomographic image and an example of a plot to assess anisotropy, according to various implementations. FIG. 11 (left pane) shows an x-ray tomographic image volume within layering heterogeneity present in the x-direction. The x-ray tomographic image has a resolution of 13.6 microns per voxel. FIG. 11 (left pane) shows an implementation of the testing tool to assess anisotropy. The plot shows coefficient of variation for probe directions given by the x-axis and z-axis. Here, covariance in grayscale values is computed rather than a petrophysical property. Representative elementary volume analysis shows that porosity uncertainty in the z-direction decreases as volume size increases. However, porosity uncertainty in the x-direction is impacted by heterogeneity existing on the length scale of sedimentary layering. It is shown that the covariance drops significantly in the z-direction, while alternating periodically in response to the layering heterogeneity in the x-direction. This demonstrates the presence of anisotropy within the image volume.

The testing tool can be configured to assess the REV % volume when larger scale heterogeneity is present in the digital volume. That is, in some circumstances the desired uncertainty in terms of REV % for a certain petrophysical property can have a domain size which is greater than that of the digital volume. The testing tool can compute the REV % by fitting a power law to the mean difference data plot and extrapolating to larger domain sizes. In FIG. 9, right pane, the power law fit to the REV data is shown by a dotted line. This projects uncertainty to domain sizes past 5000 microns.

FIG. 12 illustrates an example of a hardware configuration for a computing device 1200 that can implement the testing tool for performing one or more of the processes described above. While FIG. 12 illustrates various components contained in the computing device 1200, it will be appreciated that additional components can be added and existing components can be removed.

As illustrated in FIG. 12, the computing device 1200 can include one or more processors 1202 of varying core configurations and clock frequencies. The computing device 1200 can also include one or more memory devices 1204 that serve as a main memory during the operation of the computing device 1200. The computing device 1200 can also include one or more peripheral interfaces 1206, such as keyboards, mice, touchpads, computer screens, touchscreens, etc., for enabling human interaction with and manipulation of the computing device 1200.

The computing device 1200 can also include one or more network interfaces 1208 for communicating via one or more networks, such as Ethernet adapters, wireless transceivers, or serial network components, for communicating over wired or wireless media using protocols. The computing device 1200 can also include one or more storage devices 1210 of varying physical dimensions and storage capacities, such as flash drives, hard drives, random access memory, etc., for storing data, such as images, files, and program instructions for execution by the one or more processors 1202.

Additionally, the computing device 1200 can include one or more software programs 1212, such as the testing tool. The one or more software programs 1212 can include instructions that cause the one or more processors 1202 to perform the processes described herein. Copies of the one or more software programs 1212 can be stored in the one or more memory devices 1204 and/or in the one or more storage devices 1210. Likewise, the data utilized by one or more software programs 1212 can be stored in the one or more memory devices 1204 and/or in the one or more storage devices 1210.

In implementations, the components of the computing device 1200 as described above need not be enclosed within a single enclosure or even located in close proximity to one another. Those skilled in the art will appreciate that the above-described componentry are examples only, as the computing device 1200 can include any type of hardware componentry, including any necessary accompanying firmware or software, for performing the disclosed implementations. The computing device 1200 can also be implemented in part or in whole by electronic circuit components or processors, such as application-specific integrated circuits (ASICs) or field-programmable gate arrays (FPGAs).

While the teachings have been described with reference to examples of the implementations thereof, those skilled in the art will be able to make various modifications to the described implementations without departing from the true spirit and scope. The terms and descriptions used herein are set forth by way of illustration only and are not meant as limitations. In particular, although the method has been described by examples, the steps of the method may be performed in a different order than illustrated or simultaneously. Furthermore, to the extent that the terms “including”, “includes”, “having”, “has”, “with”, or variants thereof are used in either the detailed description and the claims, such terms are intended to be inclusive in a manner similar to the term “comprising.” As used herein, the terms “one or more of” and “at least one of” with respect to a listing of items such as, for example, A and B, means A alone, B alone, or A and B. Further, unless specified otherwise, the term “set” should be interpreted as “one or more.” Those skilled in the art will recognize that these and other variations are possible within the spirit and scope as defined in the following claims and their equivalents.

What is claimed is:

1. A method for analyzing material samples to determine material properties, the method comprising:
receiving a three-dimension (3D) digital volume, wherein the 3D digital volume is a representation of a material sample;
defining a plurality of test volumes, wherein each of the plurality of test volumes comprises a number of voxels, and wherein the number of voxels for each of the plurality of test volumes is different;
determining, for each of the plurality of test volumes, a difference value between a material property for two adjacent test volumes from the 3D digital volume, each adjacent test volume comprising the number of voxels associated with the test volume;
plotting the difference value for each of the plurality of test volumes; and
determining, from the plot, a representative elementary volume (REV) for 3D digital volume.

2. The method of claim 1, wherein determining the difference value for each of the plurality of test volumes comprises:
selecting a first portion of the 3D digital volume containing number of voxels;
selecting a second portion of the 3D digital volume that is adjacent to the first portion and contains the same number of voxels;
calculating a first material property value for the first portion;
calculating a second material property value for the second portion; and
calculating a difference value based on the first material property value and the second material property value.

3. The method of claim 2, wherein the difference value is calculated using an equation comprising:
$$p = 2 \times \frac{( {V}_{A} - {V}_{B} )}{( {V}_{A} + {V}_{B} )}$$
where p is the difference value, V_{A} is the first material property value, and V_{B} is the second material property value.

4. The method of claim 2, wherein determining the difference value for each of the plurality of test volumes further comprises:
selecting a plurality of additional portions of the 3D digital volume, each additional portion containing the number of voxels;
selecting a plurality of second additional portions of the 3D digital volume that are adjacent to the plurality of additional portions and contain the number of voxels;
calculating a plurality of material property values for the plurality of additional portions;
calculating a plurality of material property values for the plurality of second additional portions;
calculating a plurality of additional difference values based on the plurality of material property values for the plurality of additional portions and the second plurality of material property values for the plurality of second additional portions; and
calculating a mean of the difference value and the plurality of additional difference values.

5. The method of claim 1, wherein the material property comprises a physical property comprising of one or more of porosity, absolute permeability, relative permeability, electrical properties, elastic properties, and nuclear magnetic resonance.

6. The method of claim 5, wherein electrical properties comprise one or more of formation factor, resistivity index, tortuosity factor, cementation exponent, and saturation exponent.

7. The method of claim 5, wherein elastic properties comprise one or more of bulk modulus, shear modulus, Young's modulus, Poisson's ratio, compressional wave velocity, and shear wave velocity.

8. The method of claim 1, wherein the material property comprises a geometrical property comprising of one or more of correlation length, surface to volume ratio, tortuosity, chord length, grain size, grain shape, pore throat radii, pore size, and pore shape.

9. The method of claim 1, wherein the 3D digital volume comprises a 3D image volume, a 3D derivative volume, or a 3D constructed volume.

10. The method of claim 9, wherein the 3D image volume of the material sample is acquired utilizing one of x-ray tomography, micro x-ray tomography, nano x-ray tomography, focused ion beam scanning electron microscopy, nuclear magnetic resonance, or neutron tomography.

11. The method of claim 10, wherein the material sample comprises one of whole core, side wall cores, outcrops, drill cuttings, laboratory generated synthetic rock samples, sand packs, and cemented packs.

12. The method of claim 9, wherein the 3D derivative volume is generated from an image volume using one or both of image enhancement techniques and segmentation techniques.

13. The method of claim 9, wherein the 3D constructed volume is generated using numerical algorithms or simulation methods.

14. The method of claim 1, wherein the two adjacent test volumes for each of the plurality of test volume are aligned in a first direction.

15. The method of claim 14, the method further comprising:
determining, for each of the plurality of test volumes, an additional difference value between a material property for additional adjacent test volumes from the 3D digital volume, wherein the additional adjacent test volumes are aligned in a second direction orthogonal to the first direction;
plotting the additional difference values for the plurality of additional test volumes; and
determining an anisotropy of the material sample based on a comparison of the plot of the difference values and the plot of the additional difference values.

16. The method of claim 1, wherein the determining is of the same material property for adjacent test volumes.

17. The method of claim 1, wherein determining the difference value comprises direct numerical simulation of physical properties using lattice boltzmann, finite difference, finite element, or random walk techniques.

18. A computer readable storage medium comprising instructions for causing one or more processors to perform a method, comprising:
receiving a three-dimension (3D) digital volume, wherein the 3D digital volume is a representation of a material sample;
defining a plurality of test volumes, wherein each of the plurality of test volumes comprises a number of voxels, and wherein the number of voxels for each of the plurality of test volumes is different;
determining, for each of the plurality of test volumes, a difference value between a material property for two adjacent test volumes from the 3D digital volume, each adjacent test volume comprising the number of voxels associated with the test volume;
plotting the difference value for each of the plurality of test volumes; and
determining, from the plot, a representative elementary volume (REV) for the 3D digital volume.

19. The computer readable storage medium of claim 18, wherein determining the difference value for each of the plurality of test volumes comprises:
selecting a first portion of the 3D digital volume containing the number of voxels;
selecting a second portion of the 3D digital volume that is adjacent to the first portion and contains the same number of voxels;
calculating a first material property value for the first portion;
calculating a second material property value for the second portion; and
calculating a difference value based on the first material property value and the second material property value.

20. The computer readable storage medium of claim 19, wherein the difference value is calculated using an equation comprising:
$$p = 2 \times \frac{( {V}_{A} - {V}_{B} )}{( {V}_{A} + {V}_{B} )}$$
where p is the difference value, V_{A} is the first material property value, and V_{B} is the second material property value.

21. The computer readable storage medium of claim 19, wherein determining the difference value for each of the plurality of test volumes further comprises:
selecting a plurality of additional portions of the 3D digital volume each additional portion containing the number of voxels;
selecting a plurality of second additional portions of the 3D digital volume that are adjacent to the plurality of additional portions and contain the number of voxels;
calculating a plurality of material property values for the plurality of additional portions;
calculating a plurality of material property values for the plurality of second additional portions;
calculating a plurality of additional difference values based on the plurality of material property values for the plurality of additional portions and the second plurality of material property values for the plurality of second additional portions; and
calculating a mean of the difference value and the plurality of additional difference values.

22. The computer readable storage medium of claim 18, wherein the material property comprises of a physical property comprising of one or more of porosity, absolute permeability, relative permeability, electrical properties, elastic properties, and nuclear magnetic resonance.

23. The computer readable storage medium of claim 18, wherein the material property comprises of a geometrical property comprising of one or more of correlation length, surface to volume ratio, tortuosity, chord length, grain size, grain shape, pore throat radii, pore size, and pore shape.

24. The computer readable storage medium of claim 18, wherein the two adjacent test volumes for each of the plurality of test volume are aligned in a first direction.

25. The computer readable storage medium of claim 24, the method further comprising:
determining, for each of the plurality of test volumes, an additional difference value between a material property for additional adjacent test volumes from the 3D digital volume, wherein the additional adjacent test volumes are aligned in a second direction orthogonal to the first direction;
plotting the additional difference values for the plurality of additional test volumes; and
determining an anisotropy of the material sample based on a comparison of the plot of the difference values and the plot of the additional difference values.

26. The method of claim 18, wherein the determining is of the same material property for adjacent test volumes.

27. A system for analyzing material samples, the system comprising:
a scanner configured to produce a three dimensional (3D) digital volume, wherein the 3D digital volume is a representation of a material sample; and
a computing device coupled to the scanner and comprising:
one or more memory devices storing instructions; and
one or more processors coupled to the one or more memory devices and configured to execute the instructions to perform a method, comprising:
defining a plurality of test volumes, wherein each of the plurality of test volumes comprises a number of voxels, and wherein the number of voxels for each of the plurality of test volumes is different;
determining, for each of the plurality of test volumes, a difference value between a material property for two adjacent test volumes from the 3D digital volume, each adjacent test volume comprising the number of voxels associated with the test volume;
plotting the difference value for each of the plurality of test volumes; and
determining, from the plot, a representative elementary volume (REV) for 3D digital volume.

28. The system of claim 27, wherein determining the difference value for each of the plurality of test volumes comprises:
selecting a first portion of the 3D digital volume containing the number of voxels;
selecting a second portion of the 3D digital volume that is adjacent to the first portion and contains the same number of voxels;
calculating a first material property value for the first portion;
calculating a second material property value for the second portion; and
calculating a difference value based on the first material property value and the second material property value.

29. The system of claim 28, wherein the difference value is calculated using an equation comprising:
$$p = 2 \times \frac{( {V}_{A} - {V}_{B} )}{( {V}_{A} + {V}_{B} )}$$
where p is the difference value, V_{A} is the first material property value, and V_{B} is the second material property value.

30. The system of claim 28, wherein determining the difference value for each of the plurality of test volumes further comprises:
selecting a plurality of additional portions of the 3D digital volume each additional portion containing the number of voxels;
selecting a plurality of second additional portions of the 3D digital volume that are adjacent to the plurality of additional portions and contain the number of voxels;
calculating a plurality of material property values for the plurality of additional portions;
calculating a plurality of material property values for the plurality of second additional portions;
calculating a plurality of additional difference values based on the plurality of material property values for the plurality of additional portions and the second plurality of material property values for the plurality of second additional portions; and
calculating a mean of the difference value and the plurality of additional difference values.

31. The system of claim 27, wherein the material property comprises a physical property comprising of one or more of porosity, absolute permeability, relative permeability, electrical properties, elastic properties, and nuclear magnetic resonance.

32. The system of claim 27, wherein the material property comprises a geometrical property comprising of one or more of correlation length, surface to volume ratio, tortuosity, chord length, grain size, grain shape, pore throat radii, pore size, and pore shape.

33. The system of claim 27, wherein the two adjacent test volumes for each of the plurality of test volume are aligned in a first direction.

34. The system of claim 33, the method further comprising:
determining, for each of the plurality of test volumes, an additional difference value between a material property for additional adjacent test volumes from the 3D digital volume, wherein the additional adjacent test volumes are aligned in a second direction orthogonal to the first direction;
plotting the additional difference values for the plurality of additional test volumes; and
determining an anisotropy of the material sample based on a comparison of the plot of the difference values and the plot of the additional difference values.

35. The method of claim 27, wherein the determining is of the same material property for adjacent test volumes.
